(19) United States
(12) Patent Application Publication
(10) Pub. No.: US 2026/0219884 A1
(43) Pub. Date: Jul. 30, 2026

(54) SYSTEMS AND METHODS FOR CHANGING SLEEP STATES AND OPERATION OF NOTEBOOK IN CLOSED POSITION OF NOTEBOOK BASED ON DEVICE CONTEXT

(71) Applicant: Dell Products L.P., Round Rock, TX (US)

(72) Inventors: Jace W. FILES, Round Rock, TX (US); John T. MORRISON, Round Rock, TX (US); Chiu-Jung TSEN, Zhubei City (TW)

(73) Assignee: Dell Products L.P., Round Rock, TX (US)

(21) Appl. No.: 19/037,071

(22) Filed: Jan. 24, 2025

(51) Int. Cl. G06F 9/30; G06F 21/32; H04W 4/029

(52) U.S. Cl. CPC G06F 9/30072; G06F 21/32; H04W 4/029

(57) ABSTRACT

An information handling system may include a keyboard assembly, a display assembly rotatably coupled to the keyboard assembly, and a processor configured to, when the display assembly is in a closed position relative to the keyboard assembly, determine a context of the information handling system and selectively enable and disable one or more components of the information handling system while in the closed position based on the context.

### TECHNICAL FIELD

The present disclosure relates in general to information handling systems, and more particularly to systems and methods for enabling user interaction to control privacy settings of a notebook while the notebook is in a closed position.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system is a notebook computer, which may also be referred to as a laptop. A notebook may comprise a display assembly rotatably coupled to a keyboard assembly via a hinge, allowing a user to open the display assembly relative to the keyboard assembly to a desired angle, as well as close the keyboard assembly relative to the display assembly to an angle of approximately zero degrees.

Increasingly, notebooks are being designed to remain at least partially functional and undertake particular tasks when closed. For example, a notebook may playback audio, conduct an audio conference, record audio, or undertake other tasks while closed. Accordingly, it may be desirable to selectively enable and disable operation of the notebook in the closed position.

### SUMMARY

In accordance with the teachings of the present disclosure, the disadvantages and problems associated with traditional approaches to controlling a notebook in a closed position may be substantially reduced or eliminated.

In accordance with embodiments of the present disclosure, an information handling system may include a keyboard assembly, a display assembly rotatably coupled to the keyboard assembly, and a processor configured to, when the display assembly is in a closed position relative to the keyboard assembly, determine a context of the information handling system and selectively enable and disable one or more components of the information handling system while in the closed position based on the context.

In accordance with these and other embodiments of the present disclosure, an information handling system may include a display assembly, a keyboard assembly rotatably coupled to the display assembly, and a visual indicator integrated within the keyboard assembly, wherein the visual indicator comprises a fingerprint reader integrated therein for authenticating enrolled users of the information handling system.

In accordance with these and other embodiments of the present disclosure, a method may include, in an information handling system having a keyboard assembly and a display assembly rotatably coupled to the keyboard assembly, when the display assembly is in a closed position relative to the keyboard assembly, determining a context of the information handling system and selectively enabling and disabling one or more components of the information handling system while in the closed position based on the context.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates an isometric perspective view of selected components of an example notebook in an open position of the notebook, in accordance with embodiments of the present disclosure;

FIG. 3 illustrates an isometric perspective view of selected components of the notebook of FIG. 2 in a closed position of the notebook, in accordance with embodiments of the present disclosure;

FIG. 4 illustrates a zoomed-in isometric perspective view of selected components of the notebook of FIGS. 2 and 3 in a closed position of the notebook, in accordance with embodiments of the present disclosure;

FIG. 5 illustrates an exploded isometric perspective view of selected components of a visual indicator with an integrated fingerprint reader, in accordance with embodiments of the present disclosure; and

FIG. 6 illustrates a flow chart of an example method for changing sleep states and operation of a notebook in the closed position of the notebook based on device context, in accordance with embodiments of the present disclosure.

### DETAILED DESCRIPTION

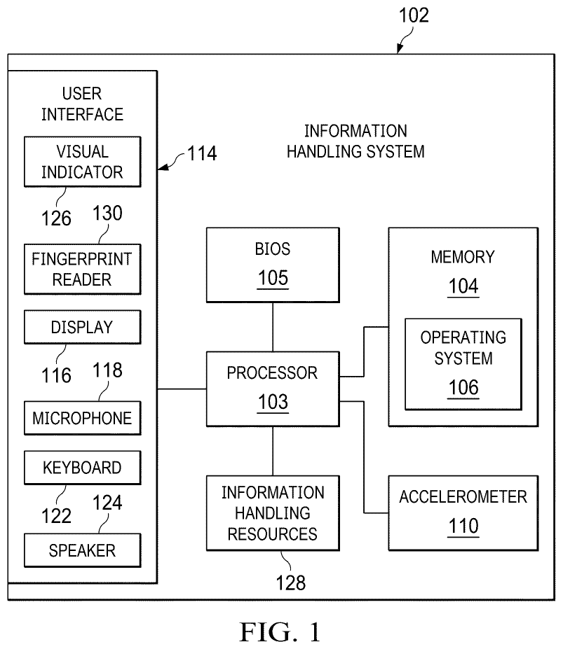

Preferred embodiments and their advantages are best understood by reference to FIGS. 1 through 6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, buses, memories, I/O devices and/or interfaces, storage resources, network interfaces, motherboards, integrated circuit packages; electro-mechanical devices (e.g., air movers), displays, and power supplies.

FIG. 1 illustrates a block diagram of selected components of an example information handling system 102, in accordance with embodiments of the present disclosure. In some embodiments, information handling system 102 may comprise or be an integral part of a server. In some embodiments, information handling system 102 may be a personal computer (e.g., a desktop computer or a portable computer). In other embodiments, information handling system 102 may comprise a mobile device (e.g., a smart phone, a tablet computing device, a handheld computing device, a personal digital assistant, or any other device that may be readily transported on a person of a user of such mobile device).

As depicted in FIG. 1, information handling system 102 may include a processor 103, a memory 104 communicatively coupled to processor 103, an accelerometer 110 communicatively coupled to processor 103, a BIOS 105, a user interface 114 communicatively coupled to processor 103, and one or more information handling resources 128 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

As shown in FIG. 1, memory 104 may have stored therein an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105.

Accelerometer 110 may be communicatively coupled to processor 103, and may include any system, device, or apparatus configured to measure acceleration (e.g., proper acceleration) experienced by information handling system 102. Accordingly, accelerometer 110 may measure a gravitational orientation of information handling system 102. Thus, accelerometer 110 may sense an orientation (e.g., horizontally laying down on a surface, vertical, etc.) of information handling system 102 and/or may sense whether information handling system 102 is in motion or stationary.

User interface 114 may comprise any instrumentality or aggregation of instrumentalities by which a user may interact with information handling system 102. For example, user interface 114 may permit a user to input data and/or instructions into information handling system 102 (e.g., via a keypad, keyboard, touch screen, microphone, camera, and/or other data input device), and/or otherwise manipulate information handling system 102 and its associated components. User interface 114 may also permit information handling system 102 to communicate data to a user (e.g., via a display device, speaker, and/or other data output device). As shown in FIG. 1, user interface 114 may include one or more of each of a display 116, a microphone 118, a keyboard 122, a speaker 124, a visual indicator 126, a fingerprint reader 130, and/or one or more other input and/or output devices.

Display 116 may comprise any suitable system, device, or apparatus configured to display human-perceptible graphical data and/or alphanumeric data to a user. For example, in some embodiments, display 116 may comprise a liquid crystal display or organic light-emitting diode display.

Microphone 118 may comprise any system, device, or apparatus configured to convert sound incident at microphone 118 to an electrical signal that may be processed by processor 103. In some embodiments, microphone 118 may include a capacitive microphone (e.g., an electrostatic microphone, a condenser microphone, an electret microphone, a microelectromechanical systems (MEMS) microphone, etc.) wherein such sound is converted to an electrical signal using a diaphragm or membrane having an electrical capacitance that varies based on sonic vibrations received at the diaphragm or membrane.

Keyboard 122 may comprise any system, device, or apparatus modeled after a typewriter keyboard which uses an arrangement of buttons or keys to act as mechanical levers or electronic switches to allow a user to enter text, numbers, and/or symbols into operating system 106 or application software running on operating system 106.

Speaker 124 may comprise any system, device, or apparatus configured to produce sound in response to electrical audio signal input.

Visual indicator 126 may comprise any system, device, or apparatus located on the exterior of information handling system 102 and configured to generate visible light to indicate information regarding information handling system 102 or its various components. For example, in some embodiments, visual indicator 126 may include a light-emitting diode. An example of information indicated by visual indicator 126 may include a status of microphone 118 (e.g., illuminated when microphone 118 is enabled), speaker 124 (e.g., illuminated when speaker 124 is enabled), a status of information handling system 102 in general (e.g., powered on or enabled for operation), and/or a status of another component of information handling system 102.

Fingerprint reader sensor 130 may include any system, device, or apparatus configured to obtain an image of a person's fingerprint, and communicate data representative of the fingerprint image to processor 103. For example, in some embodiments, fingerprint reader sensor 130 may include a capacitive scanner that uses electrical capacitors (and thus electric current) to form an image of a fingerprint. However, in other embodiments fingerprint reader sensor 130 may include an optical scanner that captures a visual image of a fingerprint using a digital camera, an ultrasonic fingerprint scanner that uses high-frequency sound waves to penetrate the epidermal (outer) layer of the user's skin, or a thermal scanner that senses the temperature differences on the contact surface, in between fingerprint ridges and valleys.

In addition to processor 103, memory 104, BIOS 105, accelerometer 110, and user interface 114, information handling system 102 may include one or more other information handling resources 128. Such an information handling resource 128 may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

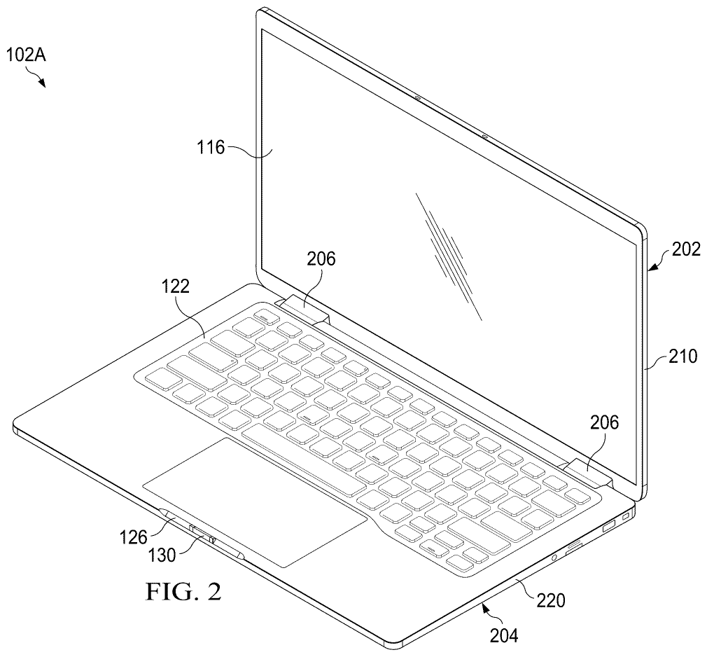

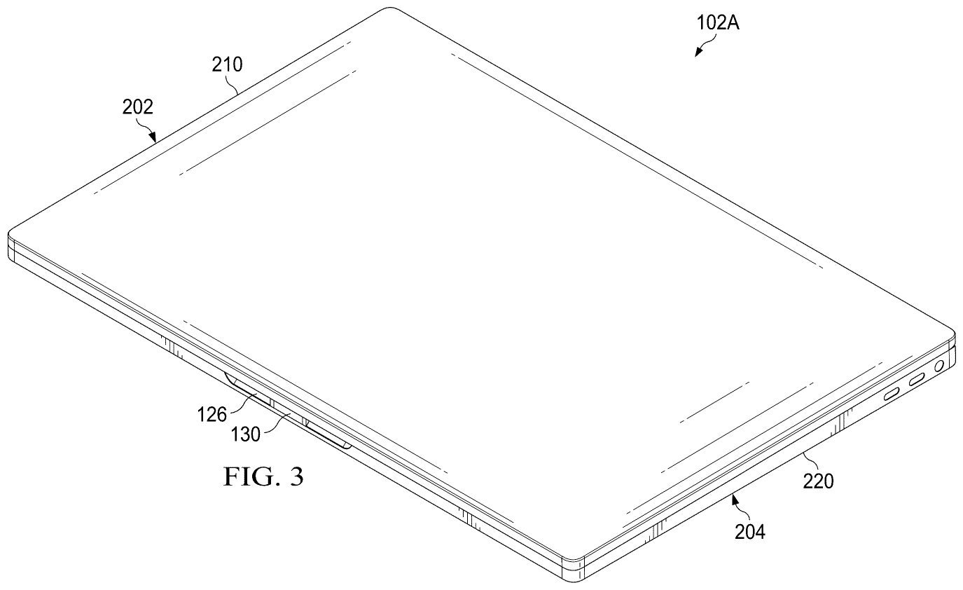

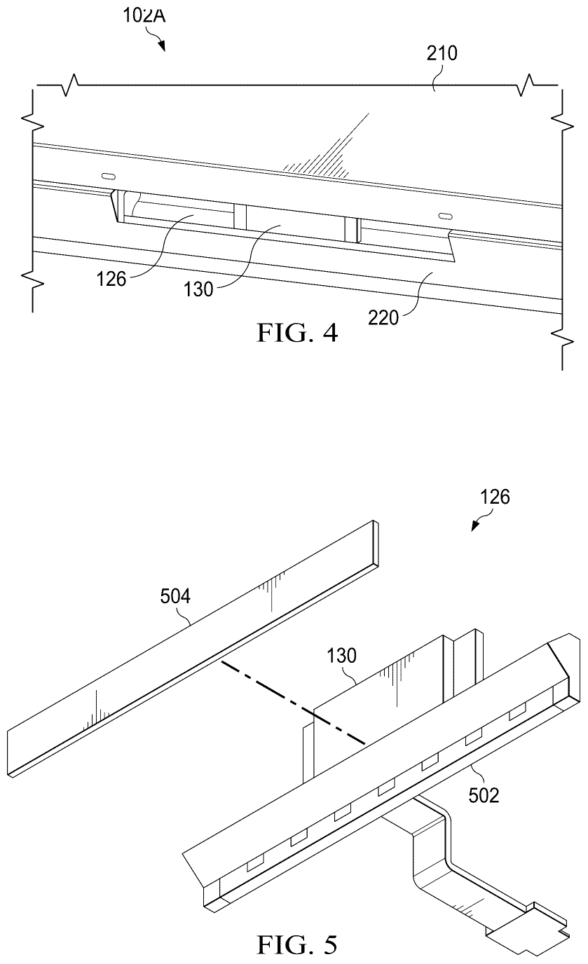

FIG. 2 illustrates an isometric perspective view of selected components of an example notebook 102A in an open position, in accordance with embodiments of the present disclosure. FIG. 3 illustrates an isometric perspective view of selected components of example notebook 102A in a closed position, in accordance with embodiments of the present disclosure. FIG. 4 illustrates a zoomed-in isometric perspective view of selected components example notebook 102A in a closed position of notebook 102A, in accordance with embodiments of the present disclosure. In some embodiments, notebook 102A may implement information handling system 102.

As shown in FIGS. 2-4, notebook 102A may include a display assembly 202 and a keyboard assembly 204 rotatably coupled to one another via one or more hinges 206. Display assembly 202 may comprise a housing 210 that may house components of notebook 102A including a display 116. Keyboard assembly 204 may comprise a housing 220 that may house components of notebook 102A including keyboard 122 for inputting information to notebook 102A. Keyboard assembly 204 may also include other components of information handling system 102 (e.g., processor 103, memory 104, BIOS 105, certain components of user interface 114, information handling resources 128, etc.) not explicitly depicted in FIGS. 2-4.

Further as shown in FIGS. 2-4, housing 220 may include visual indicator 126 and fingerprint reader 130 integrated along a front edge of housing 220. For example, as depicted in FIG. 204, fingerprint reader 130 may be integrated within visual indicator 126, with visual indicator 126 implemented as a light bar at the front edge of housing 220.

FIG. 5 illustrates and exploded isometric perspective view of selected components of visual indicator 126 with an integrated fingerprint reader 130, in accordance with embodiments of the present disclosure. As shown in FIG. 5, visual indicator 126 may comprise an assembly having fingerprint reader 130 mechanically coupled to a light-emitting diode 502 (or other light emitting device), with an at least partially transparent cover 504 (e.g., glass, plastic, etc.) for covering fingerprint reader 130 and light-emitting diode 502. In some embodiments, the assembly of visual indicator 126 may include a light guide to guide light generated by light-emitting diode 502 to cover 504.

Accordingly, visual indicator 126 and fingerprint reader 130 may be located to allow access or viewing external to housing 210 and housing 220. Thus, an enrolled user of notebook 102A may interact with fingerprint reader 130 at the front edge of notebook 102A in order to authenticate the user via fingerprint reader 130 when notebook 102A is in either of an open position or a closed position.

In operation, processor 103 may, based on contextual information associated with notebook 102A, determine whether to enable or disable operation of notebook 102A when notebook 102A is in the closed position. Such contextual information may include, without limitation, whether notebook 102A is stationary or in motion, whether notebook 102A is in a horizontal position (e.g., bottom of housing 220 horizontal upon a horizontal surface), whether a calendar of notebook 102A indicates a meeting is scheduled at a present time, and whether an enrolled user of notebook 102A has been authenticated (e.g., via fingerprint reader 130).

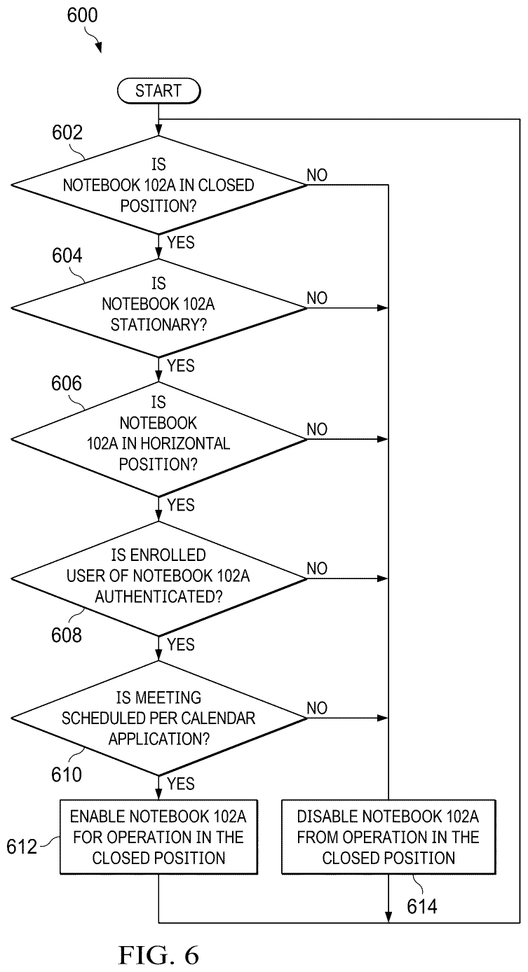

FIG. 6 illustrates a flow chart of an example method 600 for changing sleep states and operation of notebook 102A in the closed position of notebook 102A based on device context, in accordance with embodiments of the present disclosure. According to some embodiments, method 600 may begin at step 602. As noted above, teachings of the present disclosure may be implemented in a variety of configurations of notebook 102A. As such, the preferred initialization point for method 600 and the order of the steps comprising method 600 may depend on the implementation chosen.

At step 602, processor 103 may determine if notebook 102A is in the closed position. Numerous approaches for determining the position of display assembly 202 relative to keyboard assembly 204 are known in the art and are beyond the scope of this disclosure, including whether notebook 102A is in an open position or a closed position. If notebook 102A is in the closed position, method 600 may proceed to step 604. Otherwise, method 600 may proceed to step 614.

At step 604, processor 103 may determine if notebook 102A is stationary, for example based on signals communicated to processor 103 from accelerometer 110. If notebook 102A is stationary, method 600 may proceed to step 606. Otherwise, if notebook 102A method 600 may proceed to step 614.

At step 606, processor 103 may determine if notebook 102A is in a horizontal position. If notebook 102A is in a horizontal position, method 600 may proceed to step 608. Otherwise, method 600 may proceed to step 614.

At step 608, processor 103 may determine if an enrolled user of notebook 102A is authenticated (e.g., via fingerprint reader 130 or other biometric sensor). If an enrolled user of notebook 102A is authenticated, method 600 may proceed to step 610. Otherwise, method 600 may proceed to step 614.

At step 610, processor 103 may determine if a calendar application of notebook 102A indicates that a meeting is scheduled for the then-current time. If the calendar application of notebook 102A indicates that a meeting is scheduled for the then-current time, method 600 may proceed to step 612. Otherwise, method 600 may proceed to step 614.

At step 612, processor 103 may enable operation of notebook 102A in the closed position, for example to enable microphone 116, speaker 124, and/or other components of notebook 102A to facilitate an audio conference. After completion of step 612, method 600 may proceed again to step 602.

At step 614, processor 103 may disable operation of notebook 102A in the closed position, for example to disable microphone 116, speaker 124, and/or other components of notebook 102A. After completion of step 614, method 600 may proceed again to step 602.

Although FIG. 6 discloses a particular number of steps to be taken with respect to method 600, method 600 may be executed with greater or fewer steps than those depicted in FIG. 6. In addition, although FIG. 6 discloses a certain order of steps to be taken with respect to method 600, the steps comprising method 600 may be completed in any suitable order.

Method 600 may be implemented in whole or part using a variety of configurations of notebook 102A and/or any other system operable to implement method 600. In certain embodiments, method 600 may be implemented partially or fully in software and/or firmware embodied in computer-readable media.

Although the foregoing steps would indicate that steps 602-612 would repeat while notebook 102A remains in the closed position after enabled for operation in the closed position, it is understood that some of such steps may not repeat. For example, in some embodiments, once in the closed position and operation in the closed position is enabled, only steps 602 and 612 may repeat to leave notebook 102A enabled for operation in the closed position until notebook 102A is again manipulated to the open position.

While the terms “top,” “bottom,” “front,” “back,” and “side” are used for purposes of exposition and clarity, such terms are not intended to limit any of the components disclosed herein to a particular orientation or configuration.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a keyboard assembly;
a display assembly rotatably coupled to the keyboard assembly; and
a processor configured to, when the display assembly is in a closed position relative to the keyboard assembly:
determine a context of the information handling system; and
selectively enable and disable one or more components of the information handling system while in the closed position based on the context.

2. The information handling system of claim 1, wherein the context comprises whether the information handling system is stationary.

3. The information handling system of claim 1, wherein the context comprises a position of the information handling system.

4. The information handling system of claim 1, wherein the context comprises calendar information associated with the information handling system.

5. The information handling system of claim 1, wherein the context comprises whether an enrolled user of the information handling system is authenticated.

6. The information handling system of claim 5, wherein the keyboard assembly has integrated within a visual indicator, wherein the visual indicator comprises a fingerprint reader integrated therein for authenticating enrolled users of the information handling system.

7. The information handling system of claim 6, wherein the visual indicator comprises an assembly including:
a light-emitting diode;
the fingerprint reader mechanically coupled to the light-emitting diode; and
a cover configured to cover the light-emitting diode and the fingerprint reader.

8. An information handling system comprising:
a display assembly;
a keyboard assembly rotatably coupled to the display assembly; and
a visual indicator integrated within the keyboard assembly, wherein the visual indicator comprises a fingerprint reader integrated therein for authenticating enrolled users of the information handling system.

9. The information handling system of claim 8, wherein the visual indicator comprises an assembly including:
a light-emitting diode;
the fingerprint reader mechanically coupled to the light-emitting diode; and
a cover configured to cover the light-emitting diode and the fingerprint reader.

10. A method comprising, in an information handling system having a keyboard assembly and a display assembly rotatably coupled to the keyboard assembly, when the display assembly is in a closed position relative to the keyboard assembly:
determining a context of the information handling system; and
selectively enabling and disabling one or more components of the information handling system while in the closed position based on the context.

11. The method of claim 10, wherein the context comprises whether the information handling system is stationary.

12. The method of claim 10, wherein the context comprises a position of the information handling system.

13. The method of claim 10, wherein the context comprises calendar information associated with the information handling system.

14. The method of claim 10, wherein the context comprises whether an enrolled user of the information handling system is authenticated.

15. The method of claim 14, wherein the keyboard assembly has integrated within a visual indicator, wherein the visual indicator comprises a fingerprint reader integrated therein for authenticating enrolled users of the information handling system.

16. The method of claim 15, wherein the visual indicator comprises an assembly including:
a light-emitting diode;
the fingerprint reader mechanically coupled to the light-emitting diode; and
a cover configured to cover the light-emitting diode and the fingerprint reader.
